(19) United States
(12) Patent Application Publication
(10) Pub. No.: US 2016/0291395 A1
(43) Pub. Date: Oct. 6, 2016

(54) DISPLAY DEVICE AND METHOD OF MANUFACTURE

(71) Applicant: SAMSUNG DISPLAY CO., LTD., Yongin-si (KR)

(72) Inventors: Yong Seok KIM, Seoul (KR); Pil Sook KWON, Incheon (KR); Sang Il KIM, Yongin-si (KR)

(21) Appl. No.: 15/056,836

(22) Filed: Feb. 29, 2016

(30) Foreign Application Priority Data
Apr. 6, 2015 (KR) 10-2015-0048282

(51) Int. Cl. G02F 1/1333; G02F 1/1362; G02F 1/1335; G02F 1/1343; G02F 1/1368; G02F 1/1341

(52) U.S. Cl. CPC G02F 1/133377; G02F 1/1368; G02F 1/133345; G02F 1/1341; G02F 1/133512; G02F 1/134309; G02F 1/136204; G02F 1/133514; G02F 1/133516

(57) ABSTRACT

A display device including: an insulation substrate including a plurality of pixel areas; a thin film transistor positioned on the substrate; an organic layer positioned on the thin film transistor; a pixel electrode formed to be spaced apart from the organic layer with a microcavity therebetween, the pixel electrode being connected to the thin film transistor; a common electrode overlapping the pixel electrode with a roof layer therebetween; and a liquid crystal layer within the microcavity.

### CROSS-REFERENCE TO RELATED APPLICATION

This application claims priority to, and the benefit of, Korean Patent Application No. 10-2015-0048282 filed in the Korean Intellectual Property Office on Apr. 6, 2015, the entire contents of which are incorporated herein by reference.

### BACKGROUND

(a) Field

Embodiments of the present invention relate generally to flat panel displays. More specifically, embodiments of the present invention relate to a display device and its method of manufacture.

(b) Description of the Related Art

A liquid crystal display, which is one of the most common types of flat panel displays currently in use, includes two display panels with field generating electrodes such as a pixel electrode and a common electrode, and a liquid crystal layer interposed therebetween. The liquid crystal display generates an electric field in the liquid crystal layer by applying a voltage to the field generating electrodes. The resulting electric field determines the alignment of liquid crystal molecules of the liquid crystal layer and thereby controls polarization of incident light, thus displaying images.

The two display panels configuring the liquid crystal display may include a thin film transistor array panel and an opposing display panel. In the thin film transistor array panel, a gate line transferring a gate signal and a data line transferring a data signal are formed to cross each other, and a thin film transistor connected with the gate line and the data line, a pixel electrode connected with the thin film transistor, and the like may be formed. In the opposing display panel, a light blocking member, a color filter, a common electrode, and the like may be formed. In some cases the light blocking member, the color filter, and the common electrode may be formed on the thin film transistor array panel.

Liquid crystal displays of the related art employ two substrates, and respective constituent elements are formed on the two substrates as above. As a result, there are problems in that the display device is heavy and thick, has high cost, and has a long processing time.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a display device and a manufacturing method therefor having advantages of reducing a weight, a thickness, cost, and a processing time of a display, by manufacturing the display device using one substrate.

Further, embodiments of the present invention provide a display device and a manufacturing method therefor, having advantages of simplifying the fabrication process by reducing the number of masks used.

An exemplary embodiment of the present invention provides a display device including: an insulation substrate including a plurality of pixel areas; a thin film transistor positioned on the substrate; an organic layer positioned on the thin film transistor; a pixel electrode formed to be spaced apart from the organic layer with a microcavity therebetween, the pixel electrode being connected to the thin film transistor; a common electrode overlapping the pixel electrode with a roof layer therebetween; and a liquid crystal layer within the microcavity.

The display device may further include an overcoat formed on the common electrode to seal the microcavity.

The display device may further comprise a plurality of microcavities, and the microcavities may be arranged in a matrix form to respectively correspond to the plurality of pixel areas, and a light blocking member may be formed between the microcavities adjacent in the column direction.

The roof layer may at least partially cover the light blocking member.

The common electrode may comprises a plurality of distinct electrodes each positioned on a respective one of the microcavities.

The common electrodes may comprise a single unitary and continuous electrode extending over more than one of the microcavities.

The display device may further include an electrostatic protection electrode formed on a surface where the thin film transistor of the insulation substrate is not formed.

The electrostatic protection electrode may be a transparent electrode substantially covering the insulation substrate.

The roof layer may be an inorganic layer, and a thickness of the roof layer may be from 0.5 μm to 0.8 μm.

The display device may further include an organic roof layer formed on the common electrode.

The display device may further include an inorganic layer formed on the common electrode.

A color filter may be formed between the thin film transistor and the organic layer.

Another exemplary embodiment of the present invention provides a method of manufacturing a display device, the method including: forming a thin film transistor on a substrate; forming an organic layer on the thin film transistor; forming a sacrificial layer on the organic layer; forming a pixel electrode on the sacrificial layer, the pixel electrode being connected to the thin film transistor; forming a light blocking member on the organic layer so as not to overlap the sacrificial layer; forming a roof layer on the pixel electrode and the light blocking member; forming a common electrode on the roof layer and overlapping the pixel electrode; exposing the sacrificial layer; forming a microcavity between the organic layer and the pixel electrode by removing the exposed sacrificial layer; forming a liquid crystal layer by injecting a liquid crystal material into the microcavity; and forming an overcoat on the common electrode to seal the microcavity.

The method may further include forming a color filter on the thin film transistor, before the forming an organic layer on the thin film transistor.

The method may further include forming an electrostatic protection electrode on a surface of the insulation substrate upon which the thin film transistor is not formed.

The method may further include forming an organic roof layer on the common electrode, before the forming an overcoat on the common electrode to seal the microcavity.

The method may further include forming an inorganic layer on the common electrode, before the forming an overcoat on the common electrode to seal the microcavity.

The number of masks used in the method may be 11 or less.

The roof layer may be an inorganic layer.

A thickness of the roof layer may be from 0.5 μm to 0.8 μm.

As described above, according to exemplary embodiment of the present invention, it is possible to reduce the weight, thickness, cost, and processing time of a display by manufacturing the display device using one substrate.

### BRIEF DESCRIPTION OF THE DRAWINGS

FIG. 1 is a plan view illustrating a display device according to an exemplary embodiment of the present invention.

FIG. 2 is a plan view illustrating one pixel in the display device according to the exemplary embodiment of the present invention.

FIG. 3 is a cross-sectional view taken along line III-III of FIG. 1, according to the exemplary embodiment of the present invention.

FIG. 4 is a cross-sectional view taken along line IV-IV of FIG. 1, according to the exemplary embodiment of the present invention.

FIG. 5 is a cross-sectional view illustrating the same cross section as FIG. 3 in a display device according to another exemplary embodiment of the present invention.

FIG. 6 is a cross-sectional view illustrating the same cross section as FIG. 3 in a display device according to a Comparative Example.

FIGS. 7 to 16 are cross-sectional views illustrating a method of manufacturing the display device according to the exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. The various Figures are thus not to scale. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

All numerical values are approximate, and may vary. All examples of specific materials and compositions are to be taken as nonlimiting and exemplary only. Other suitable materials and compositions may be used instead.

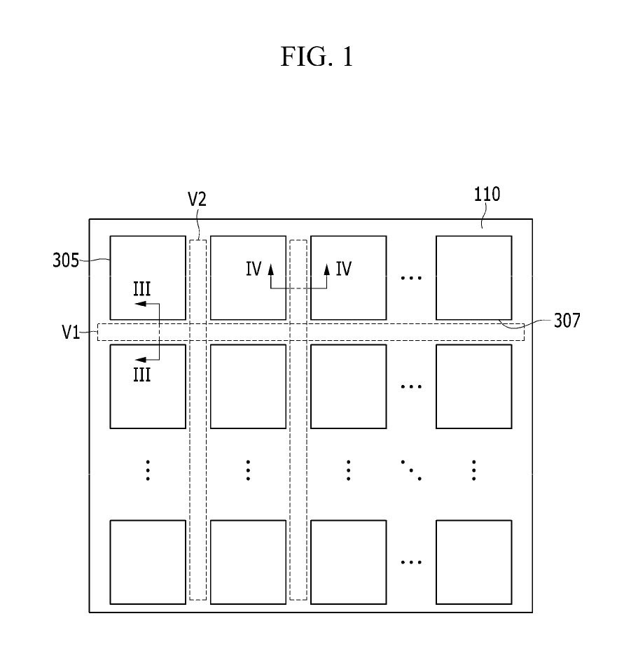

First, a display device according to an exemplary embodiment of the present invention will be described below with reference to FIG. 1. FIG. 1 is a plan view illustrating a display device according to an exemplary embodiment of the present invention.

A display device according to the exemplary embodiment of the present invention includes a substrate 110 made of a material such as glass or plastic.

A plurality of microcavities 305 is formed on the substrate 110. The microcavities 305 may be disposed in a matrix form, where injection hole formation regions V1 are positioned between successive microcavities 305 in a column direction, and partition wall formation portions V2 are positioned between successive microcavities 305 in a row direction.

The interior of the microcavity 305 may be exposed by a hole in the microcavity 305 that faces the injection hole formation region V1. This is called an inlet 307. The inlet 307 is formed at one-side edge of the microcavity 305.

The microcavity 305 exposed by the inlet 307 contacts an overcoat 390.

A partition wall which separates adjacent microcavities 305 from each other is formed at the partition wall formation portion V2. In the exemplary embodiment, the partition wall may be formed by the overcoat 390.

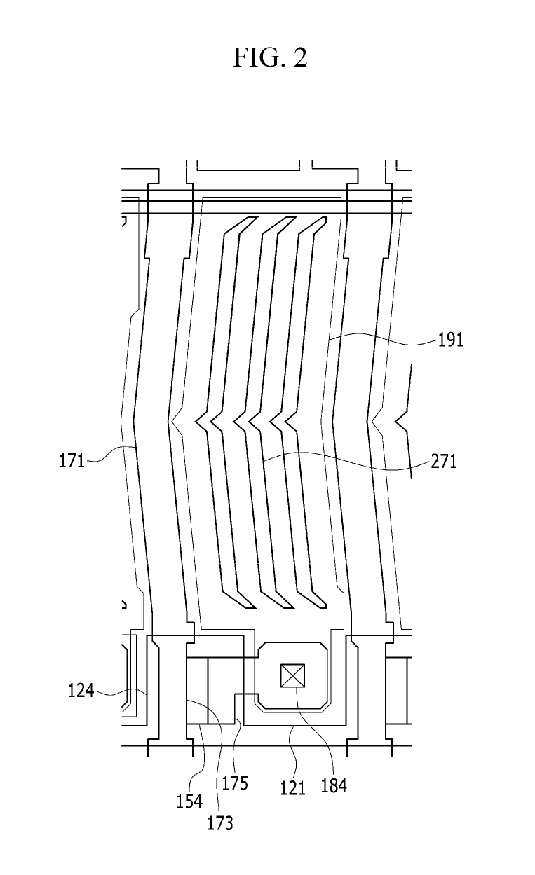

Hereinafter, the display device according to the exemplary embodiment of the present invention will be described in detail with reference to FIGS. 2 to 4.

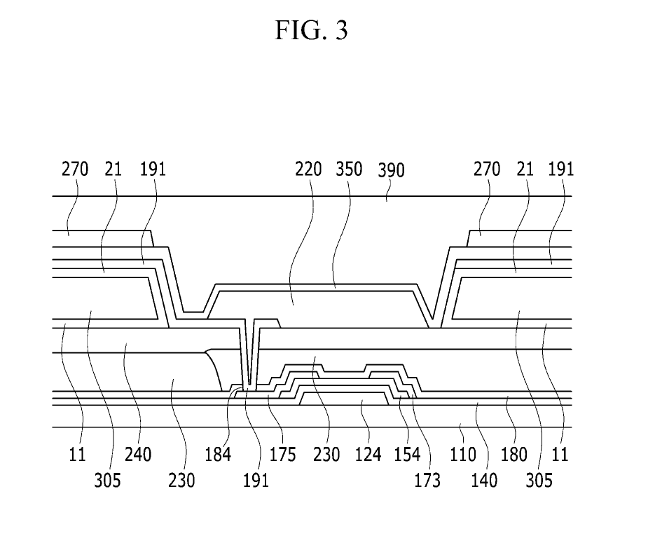

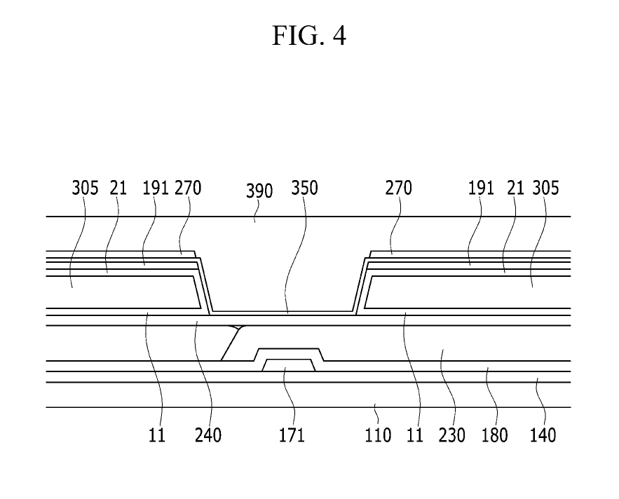

FIG. 2 is a plan view illustrating one pixel in the display device according to the exemplary embodiment of the present invention. FIG. 3 is a cross-sectional view taken along line III-III of FIG. 1 according to the exemplary embodiment of the present invention, and FIG. 4 is a cross-sectional view taken along line IV-IV of FIG. 1 according to the exemplary embodiment of the present invention.

First, a gate conductor including a gate line 121 is formed on an insulation substrate 110 made of transparent glass, plastic, or the like.

The gate line 121 includes a gate electrode 124 and a wide end portion (not illustrated) for connecting to other layers or to an external driving circuit. The gate line 121 may be made of aluminum-based metal such as aluminum (Al) or an aluminum alloy, silver-based metal such as silver (Ag) or a silver alloy, copper-based metal such as copper (Cu) or a copper alloy, molybdenum-based metal such as molybdenum (Mo) or a molybdenum alloy, chromium (Cr), tantalum (Ta), titanium (Ti), and the like. However, the gate line 121 may have a multilayered structure including at least two conductive layers having different physical properties.

A gate insulating layer 140 made of silicon nitride (SiNx), silicon oxide (SiOx), or the like is formed on the gate conductor. The gate insulating layer 140 may have a multilayered structure including at least two insulating layers having different physical properties.

A semiconductor 154 made of amorphous silicon or polysilicon is formed on the gate insulating layer 140. The semiconductor 154 may include an oxide semiconductor.

An ohmic contact (not illustrated) is formed on the semiconductor 154. The ohmic contact (not illustrated) may be made of a material such as n+ hydrogenated amorphous silicon in which an n-type impurity such as phosphorus is doped at a high concentration, or silicide. Pairs of the ohmic contacts (not illustrated) may be disposed on each semiconductor 154. In the case where semiconductor 154 is an oxide semiconductor, the ohmic contacts may be omitted.

A data conductor, including a data line 171 that in turn includes a source electrode 173 and a drain electrode 175, is formed on the semiconductor 154 and the gate insulating layer 140.

The data line 171 includes a wide end portion (not illustrated) for connecting with another layer or with an external driving circuit. The data line 171 transfers a data signal, and mainly extends in a vertical direction to cross the gate line 121.

In this case, the data line 171 may have a first curved or bent portion having a curved, bent, or perhaps chevron shape, in order to acquire maximum transmittance of the liquid crystal display. The curved portions meet each other in a middle region of a pixel area to form a V-shape. A second curved portion, which is curved to form a predetermined angle with the first curved portion, may be further included in the middle region of the pixel area.

The first curved portion of the data line 171 may be curved to form an angle of about 7° with a vertical reference line that is perpendicular to the direction of extension of the gate line 121. The second curved portion disposed in the middle region of the pixel area may be further curved to form an angle of about 7° to about 15° with the first curved portion.

The source electrode 173 is a part of the data line 171. The drain electrode 175 is formed to extend parallel to the source electrode 173. Accordingly, the drain electrode 175 is parallel with part of the data line 171.

The gate electrode 124, the source electrode 173, and the drain electrode 175 form a thin film transistor (TFT) together with the semiconductor 154, and a channel of the thin film transistor is formed in the semiconductor 154 between the source electrode 173 and the drain electrode 175.

The display device according to the exemplary embodiment of the present invention includes the source electrode 173 which is part of the data line 171, and the drain electrode 175 extending in parallel with the data line 171. As a result, a width of the thin film transistor may be increased without increasing an area occupied by the data conductor, thereby increasing an aperture ratio of the display device.

However, in the case of a display device according to another exemplary embodiment of the present invention, the source electrode 173 and the drain electrode 175 may have shapes that differ from the above.

The data line 171 and the drain electrode 175 may be made of a refractory metal such as molybdenum, chromium, tantalum, and titanium or an alloy thereof, and may have a multilayered structure including a refractory metal layer (not illustrated) and a low resistive conductive layer (not illustrated). An example of the multilayered structure may include a double layer of a chromium or molybdenum (or alloy) lower layer and an aluminum (or alloy) upper layer, or a triple layer of a molybdenum (or alloy) lower layer, an aluminum (or alloy) middle layer, and a molybdenum (or alloy) upper layer. However, the data line 171 and the drain electrode 175 may be made of various metals or conductors other than the metals.

A passivation layer 180 is disposed on the data conductor 171, 173, and 175, the gate insulating layer 140, and an exposed portion of the semiconductor 154. The passivation layer 180 may be made of an inorganic insulating material or an organic insulating material.

A color filter 230 in each pixel PX is formed on the passivation layer 180. Each color filter 230 may display one primary color such as one of red, green and blue. The color filter 230 is not limited to the three primary colors of red, green and blue, but may display one of cyan, magenta, yellow, and white-based colors. Unlike those illustrated above, the color filter 230 may be shaped so as to be elongated in a column direction between the adjacent data lines 171.

An organic layer 240 is disposed on the color filter 230. The organic layer 240 has a thickness larger than that of the passivation layer 180, and may have a substantially flat upper surface.

The organic layer 240 is disposed in the display area where the plurality of pixels is positioned, but may not be positioned in the peripheral area where the gate pad portion or the data pad portion is formed. Alternatively, the organic layer 240 may be positioned even in the peripheral area where the gate pad portion or the data pad portion is formed.

The organic layer 240, the color filter 230, and the passivation layer 180 have contact holes 184 formed therethrough.

A microcavity 305 is formed on the organic layer 240.

A pixel electrode 191 is formed on the microcavity 305. The pixel electrode 191 may be formed of a transparent conductive layer such as ITO or IZO. The pixel electrode 191 is physically and electrically connected with the drain electrode 175 through the contact holes 184 formed in the organic layer 240, the color filter 230, and the passivation layer 180, so as to receive a voltage from the drain electrode 175. The pixel electrode 191 has a plurality of first cutouts 92, and includes a plurality of first branch electrodes 192 defined by the plurality of first cutouts 92.

The pixel electrode 191 and the data line 171 may have first curved portions having a curved shape, where the curved portions meet each other in a middle region of the pixel area to form a V shape. A second curved portion, which is curved to form a predetermined angle with the first curved portion, may be further included in the middle region of the pixel area.

The first curved or angled portion may be curved or inclined to form an angle of approximately 7° with respect to a vertical reference line y (a reference line extending in a y direction) which forms an angle of 90° with a direction (x direction) of extension of the gate line 121. The second curved or angled portion disposed in the middle region of the pixel area may be further curved or inclined to form an angle of approximately 7° to approximately 15° with the first curved portion.

A light blocking member 220 is formed between adjacent microcavities 305, in the injection hole formation region V1. Such a light blocking member 220 may be positioned on the pixel electrode 191 and a portion of the organic layer 240 which is not covered by the pixel electrode 191. The light blocking member 220 is formed on the transistor to prevent light leakage.

The light blocking member 220 extends along the gate line 121, and in the present embodiment, a configuration in which only a horizontal light blocking member is formed in the injection hole formation region V1 is illustrated, but a vertical light blocking member may also be formed along the partition wall formation portion V2.

The microcavity 305 is surrounded by the pixel electrode 191 and the organic layer 240. A width and an area of the microcavity 305 may be variously modified as desired according to, for example, a size and a resolution of the display device.

A first alignment layer 11 is formed on the organic layer 240 of the microcavity 305. A second alignment layer 21 is formed below the pixel electrode 191 so as to face the first alignment layer 11. The first alignment layer 11 and the second alignment layer 21 may be connected to each other at the edge of the microcavity 305.

The first alignment layer 11 and the second alignment layer 21 may be vertical alignment layers, and made of alignment materials such as polyamic acid, polysiloxane, and polyimide. The first and second alignment layers 11 and 21 may be connected to each other at the edge of the pixel area PX as illustrated in FIGS. 3 and 4.

A liquid crystal layer configured by liquid crystal molecules 310 is formed in the microcavity 305, positioned between the pixel electrode 191 and the organic layer 240.

A roof layer 350 is positioned on the pixel electrode 191 and the light blocking member 220. The roof layer 350 may be made of an inorganic insulating material such as silicon nitride (SiNx), silicon oxide (SiOx), and silicon oxynitride (SiOxNy). The roof layer 350 serves to prevent the liquid crystal from being contaminated by contacting the light blocking member 220 when the liquid crystal is injected, and also acts to insulate the common electrode 270 and the pixel electrode 191 from each other by covering an upper portion and a side of the light blocking member 220.

That is, in the present invention, the roof layer 350 simultaneously serves as an insulating layer between the pixel electrode 191 and the common electrode 270, a capping layer of the light blocking member 220, and a roof layer supporting the upper portion of the microcavity 305.

In the case of a conventional display device according to a Comparative Example, the common electrode 270 and the pixel electrode 191 are positioned below the microcavity 305. Accordingly, the insulating layer insulating the common electrode 270 and the pixel electrode 191 from each other and the capping layer capping the upper portion of the light blocking member 220 would be formed by a separate process. Further, a separate roof layer would be formed on the microcavity 305.

However, in the display device according to the exemplary embodiment of the present invention, the common electrode 270 and the pixel electrode 191 are positioned on the microcavity 305, the roof layer 350 between the common electrode 270 and the pixel electrode 191 also serves as the capping layer of the light blocking member 220, and the roof layer 350 also serves as the roof layer covering the microcavity 305, and as a result, the number of processes and the number of masks are reduced.

Even though the common electrode 270 is formed to overlap the pixel electrode 191, the roof layer 350, which is an electrical insulator, is formed on the pixel electrode 191 to prevent the common electrode 270 and the pixel electrode 191 from being short-circuited by contacting each other.

A thickness of the roof layer 350 may be from 0.5 μm to 0.8 μm.

The common electrode 270 is formed on the roof layer 350. The common electrode 270 is formed of a transparent conductive layer such as ITO or IZO.

The common electrode 270 may be formed by covering an upper surface of the microcavity 305 without covering a side thereof.

According to the exemplary embodiment illustrated in FIG. 4, the common electrodes 270 on the microcavities 305 adjacent in the row direction are separated from each other. However, in another exemplary embodiment, the common electrodes 270 on the microcavities 305 adjacent in the row direction are connected to each other as one to have a plate shape.

The pixel electrode 191 receives a data voltage from the drain electrode 175, and the common electrode 270 receives a reference voltage having a predetermined magnitude from a reference voltage applying unit disposed outside the display area.

The pixel electrode 191 and the common electrode 270 together generate an electric field via their applied voltages, and the liquid crystal molecules of the liquid crystal layer 310 positioned between the two electrodes 191 and 270 are oriented parallel to the direction of the electric field. Polarization of light passing through the liquid crystal layer varies according to the rotation directions of the liquid crystal molecules.

The inlet 307 exposing a part of the microcavity 305 is formed in the injection hole formation region V1.

The inlet 307 according to the exemplary embodiment of the present invention is a hole or opening formed in a side of the microcavity 305, and may be formed at one edge of the pixel area PX. For example, the inlet 307 may correspond to a lower side of the pixel area PX to expose one surface of the microcavity 305. Alternatively, the inlet 307 may be formed to correspond to an upper side of the pixel area PX, or any other side as desired.

Further, the inlets 307 of adjacent microcavities 305 may be formed to face each other. Alternatively, the inlets 307 may also be formed at any two or more edges of one microcavity 305.

Since the interior of the microcavity 305 is exposed by the inlet 307, an aligning agent, a liquid crystal material, or the like may be injected into the microcavity 305 through the inlet 307.

An overcoat 390 may be formed on the common electrode 270. The overcoat 390 is formed to cover the inlet 307. That is, the overcoat 390 may seal the microcavity 305 so as to prevent the liquid crystal molecules 310 placed in the microcavity 305 from being discharged, or leaking out, to the outside. Since the overcoat 390 contacts the liquid crystal molecules 310, the overcoat 390 may be made of a material which does not react with liquid crystal molecules 310. For example, the overcoat 390 may be made of parylene or the like.

The overcoat 390 may be formed as a multilayer such as a double layer or a triple layer. The double layer is configured by two layers made of different materials. The triple layer is configured by three layers, and materials of adjacent layers may be different from each other. For example, the overcoat 390 may include a layer made of an organic insulating material and a layer made of an inorganic insulating material.

The overcoat 390 may serve as the partition wall 390 while filling the partition wall formation portion V2 between the microcavities 305 adjacent in the row direction.

As described above, in the display device according to the exemplary embodiment of the present invention, the common electrode 270 and the pixel electrode 191 are positioned on the microcavity 305, the insulating layer between the common electrode 270 and the pixel electrode 191 also serves as the roof layer 350 and the capping layer of the light blocking member 220, and as a result, the number of processes and the number of masks are reduced.

Further, the roof layer is inorganic instead of organic, and is formed between the common electrode and the pixel electrode, thereby simplifying the process and reducing the number of masks.

Accordingly, the thickness of the display device may be thinner than that of conventional structures that include an organic roof layer, an insulating layer, and a capping layer.

Further, conventional displays exhibit a problem in that the shape of the microcavity is not sufficiently maintained. However, in the case of the display device according to the exemplary embodiment of the present invention, the roof of a microcavity is formed by a triple structure of the pixel electrode 191/the roof layer 350/the common electrode 270, so as to be structurally more rigid and stable. Accordingly, the shape of the microcavity 305 may be further maintained and problems such as sagging of the microcavity 305 may be prevented.

In the above exemplary embodiment, a structure in which the overcoat 390 is formed directly on the common electrode 270 is described. However, in a display device according to another exemplary embodiment of the present invention, an organic roof layer or a roof layer and an additional inorganic layer may be included on the common electrode 270.

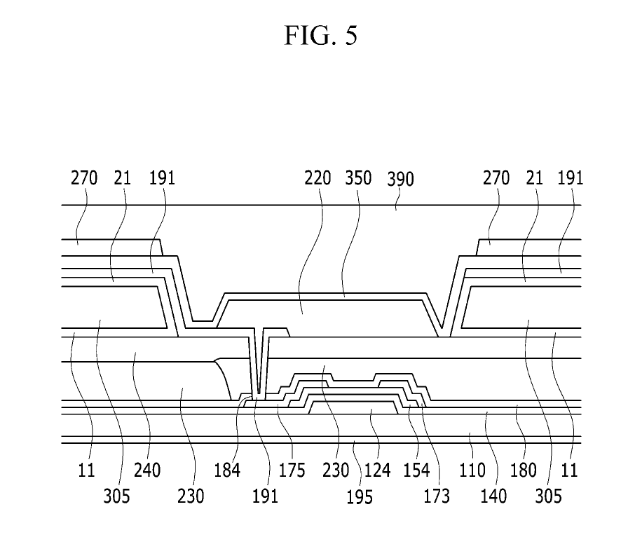

FIG. 5 is a cross-sectional view illustrating the same cross section as FIG. 3 in a display device according to another exemplary embodiment of the present invention. The liquid crystal display according to the exemplary embodiment is similar to the liquid crystal display according to the exemplary embodiment illustrated in FIG. 3. Repetitive detailed description of similar constituent elements will be omitted.

In the case of the display device according to the exemplary embodiment, an electrostatic protection electrode 195 formed below the substrate 110 is additionally included. Such an electrostatic protection electrode 195 serves to prevent static electricity generated when the display device is driven.

The electrostatic protection electrode 195 may be formed of a transparent conductive layer such as ITO or IZO.

The electrostatic protection electrode 195 is preferably formed on an opposite surface to the surface where the pixel electrode 191 and the common electrode 270 are formed.

In the case of the display device according to the Comparative Example, since the common electrode and the pixel electrode are formed below the microcavity, the electrostatic protection electrode 195 is preferably formed on the overcoat 390. In this case, there is a disadvantage in that a planarization process of the overcoat 390 may be required or the electrostatic protection electrode 195 may not easily be attached.

However, in the display device according to the exemplary embodiment of the present invention, since the common electrode 270 and the pixel electrode 191 are positioned on the microcavity 305, the electrostatic protection electrode 195 may be formed below the substrate. Accordingly, there is an advantage in that the electrostatic protection electrode 195 is more easily attached.

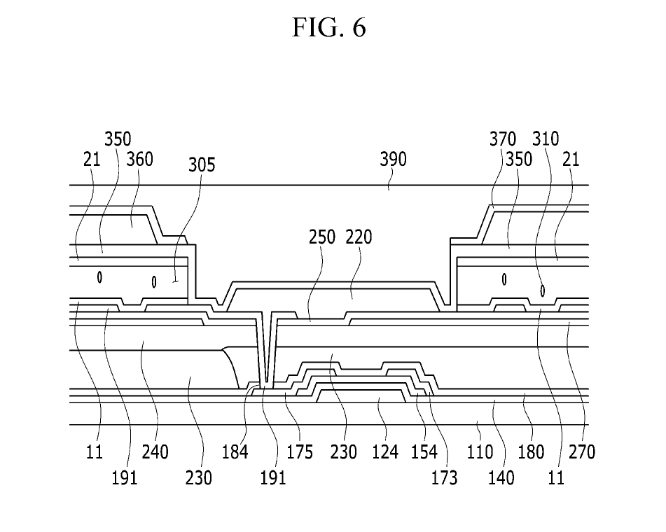

FIG. 6 is a cross-sectional view illustrating the same cross section as FIG. 3 in a display device according to a Comparative Example. Referring to FIG. 6, in the display device according to the Comparative Example, the pixel electrode 191 and the common electrode 270 are both positioned below the microcavity 305. Accordingly, the insulating layer 250 is formed between the pixel electrode 191 and the common electrode 270, and further, the capping layer 350 for preventing contamination of the liquid crystal due to the light blocking member 220 is separately formed.

Further, the roof layer 360 is separately formed on the capping layer 350, and an additional inorganic layer 370 is formed on the roof layer.

That is, in comparison with embodiments of the present invention, a separate structure of the capping layer 350, the roof layer 360, and the inorganic layer 370 is further included. In order to form the structure, a separate process and masks are used, which increases process time and costs.

However, in the display device according to the exemplary embodiment of the present invention, the common electrode 270 and the pixel electrode 191 are both positioned on the microcavity 305, the insulating layer between the common electrode 270 and the pixel electrode 191 also serves as the capping layer of the light blocking member 220 and the roof layer 350, and as a result, the number of processes and the number of masks are reduced.

Further, referring to FIG. 6, in the display device according to the Comparative Example, only a single inorganic layer (capping layer 350) exists on the microcavity 305, and thus there is a problem in that the shape of the microcavity 305 is not sufficiently maintained. Further, there is a problem in that the roof may sag due to the weight of the roof layer 360 formed on the capping layer 350.

However, in the case of the display device according to the exemplary embodiment of the present invention, since the triple structure of the pixel electrode 191/the roof layer 350/the common electrode 270 is formed on the microcavity 305, the shape of the microcavity 305 may be more stably supported.

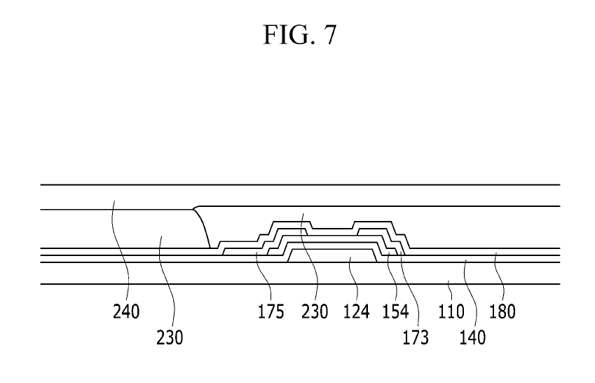

A manufacturing method for a display device according to another exemplary embodiment of the present invention will now be described with reference to FIGS. 7 to 16.

FIGS. 7 to 16 are process cross-sectional views illustrating a method of manufacturing a display device according to another exemplary embodiment of the present invention.

First, as illustrated in FIG. 7, a gate line 121 including a gate electrode 124 is positioned on an insulation substrate 110, and a gate insulating layer 140 is formed on the gate line 121. A semiconductor 154, and a data line 171 including a source electrode 173 and a drain electrode 175, are formed on the gate insulating layer 140. A passivation layer 180 is formed on the data line 171 and the drain electrode 175.

Next, a color filter 230 is formed in each pixel area PX on the first passivation layer 180. The color filter 230 is formed in each pixel area PX, but may not be formed in the injection hole formation region V1. Further, color filters 230 of the same color may be formed in a column direction of the plurality of pixel areas PX. In the case of forming color filters 230 of three colors, a first color filter 230 may be first formed, and then a second color filter 230 may be formed by shifting a mask. Next, the second color filter 230 is formed and then a third color filter may be formed by shifting the mask again.

An organic layer 240 is then formed on the color filter 230.

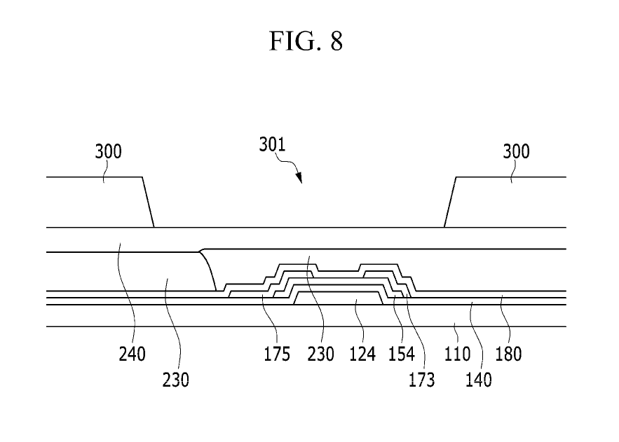

Next, referring to FIG. 8, a sacrificial layer 300 is formed by coating a photosensitive organic material on the organic layer 240 and performing a photolithography process.

The sacrificial layer 300 is formed to be connected along a plurality of pixel columns. That is, the sacrificial layers 300 are formed to cover each pixel area PX, and the photosensitive organic material is removed from each partition wall formation portion V2. Further, an opening 301 is formed by removing part of the sacrificial layer 300 through a photolithography process. The opening may be formed to be adjacent to, or correspond to, the injection hole formation region V1. Part of the organic layer 240 may be exposed by the opening 301.

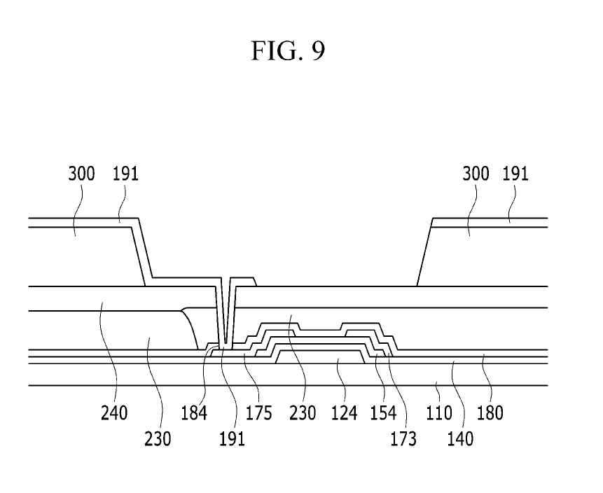

Next, referring to FIG. 9, a contact hole 184 is formed by etching the passivation layer 180, the color filter 230, and the organic layer 240 so that a part of the drain electrode 175 is exposed. Subsequently, a pixel electrode 191 is formed in the pixel area PX by depositing and patterning a transparent metal material such as indium tin oxide (ITO) and indium zinc oxide (IZO) on the sacrificial layers 300 and the exposed organic layer 240. The pixel electrode 191 is formed to be connected with the drain electrode 175 through the contact hole 184.

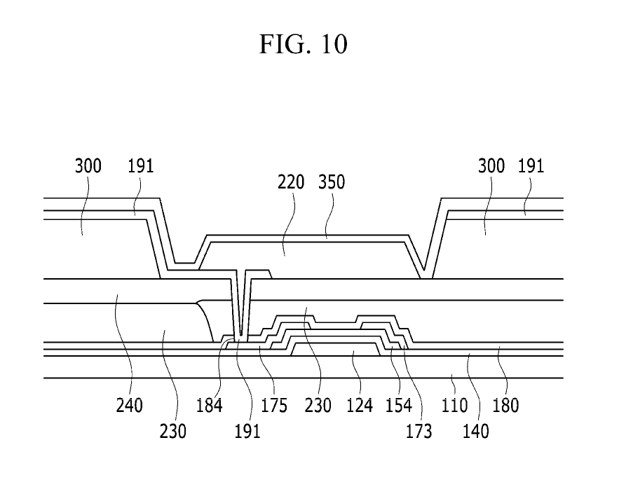

Next, referring to FIG. 10, the light blocking member 220 is formed at the injection hole formation region V1. Thereafter, the roof layer 350 is formed on the pixel electrode 191 and the light blocking member 220. The roof layer 350 may be made of an inorganic insulating material such as silicon nitride (SiNx) and silicon oxide (SiOx).

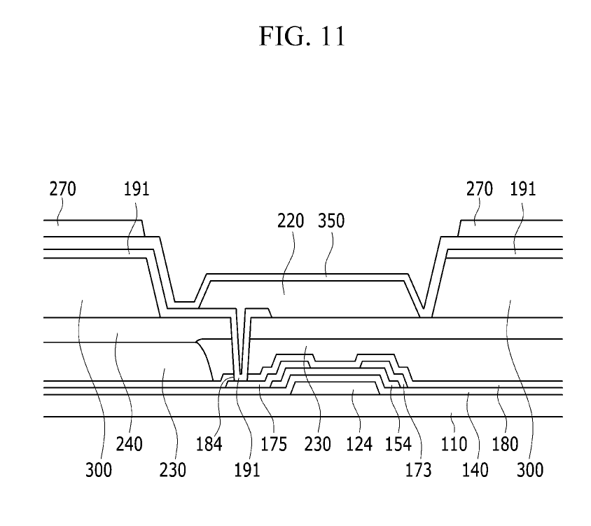

Next, referring to FIG. 11, the common electrode 270 is formed on the roof layer 350. The common electrodes 270 may be separated from each other for every microcavity 305 adjacent in a row direction and a column direction. That is, at the injection hole formation region V1 and the partition wall formation portion V2, the common electrode 270 may not be formed.

Alternatively, the common electrode 270 may be connected to microcavities 305 that are adjacent in the row direction. That is, the common electrode 270 is not formed in the injection hole formation region V1, but the common electrode 270 may be formed at the partition wall formation portion V2, so that each common electrode 270 extends in continuous and unbroken manner across multiple pixel areas of a single pixel row.

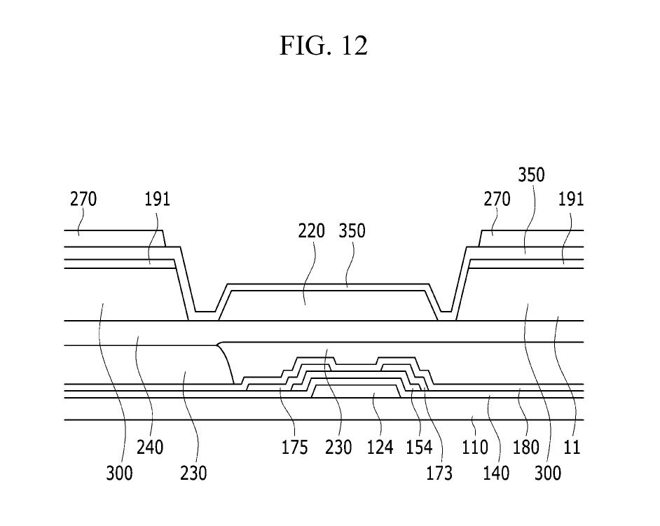

FIG. 12 illustrates a cross section of an area where a liquid crystal injection hole is formed, during the same step as that shown in FIG. 11.

That is, both FIG. 11 and FIG. 12 are cross sections which are cut vertically through the injection hole formation region V1, but FIG. 11 is a cross section cutting through a point where the pixel electrode 191 and the drain electrode 175 contact each other, and FIG. 12 illustrates a cut region where the pixel electrode 191 and the drain electrode 175 do not contact each other and where the liquid crystal injection hole is present.

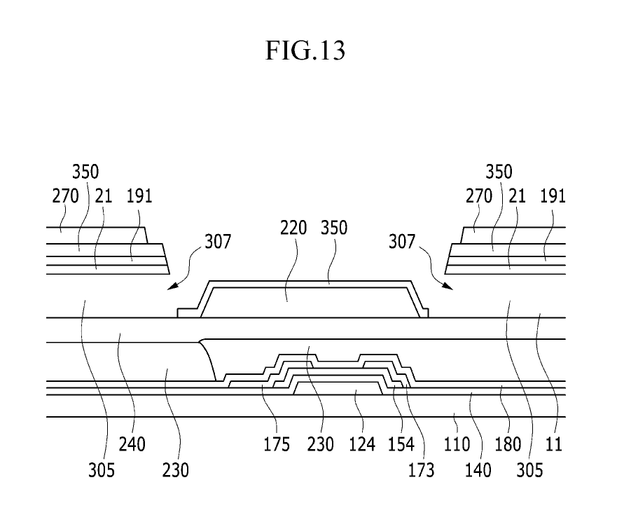

Hereinafter, for convenience of description, the same cross section as FIG. 12 will be described with reference to FIGS. 13 to 16.

Referring to FIG. 13, the roof layer 350 covering a side of the sacrificial layer 300 is patterned. As such, the sacrificial layer 300 positioned in the injection hole formation region V1 is exposed by patterning the roof layer 350.

The sacrificial layer 300 is fully removed by applying a developer on the substrate 110 where the sacrificial layer 300 is exposed, or the sacrificial layer 300 is fully removed by using an ashing process.

When the sacrificial layer 300 is removed, the microcavity 305 is generated at a site where the sacrificial layer 300 had been positioned. That is, microcavities 305 are formed by the vacancies left once the sacrificial layer 300 is removed.

The microcavity 305 have holes or openings where the roof layer 350 is removed, and each of these holes/openings may be referred to as an inlet 307. The inlets 307 are formed along the injection hole formation region V1. For example, the inlets 307 may be formed at both upper and lower edges of the pixel areas PX. Alternatively, the inlet 307 may be formed so as to expose the side of each microcavity 305 that corresponds to either an upper edge or a lower edge of its pixel area PX.

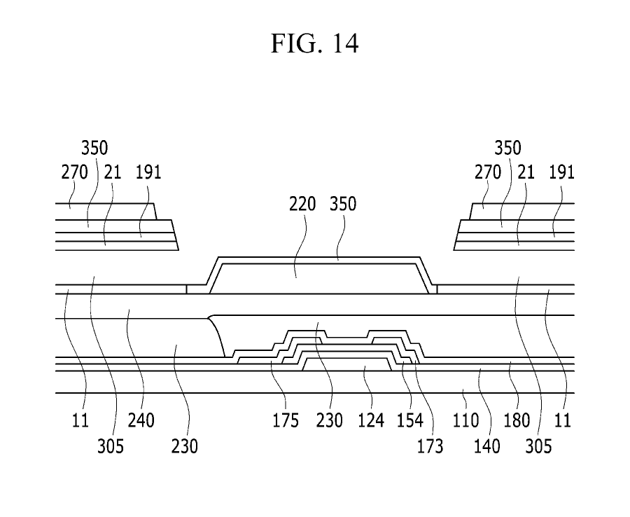

Next, as illustrated in FIG. 14, when an aligning agent including an alignment material is dropped or deposited on the substrate 110 by a spin coating method or an inkjet method, the aligning agent is injected into the microcavity 305 through the inlet 307. When the alignment agent is injected into the microcavity 305 and then a curing process is performed, the solvent of the alignment agent is evaporated and the alignment material remains on the inner wall of the microcavity 305.

Accordingly, the first alignment layer 11 may be formed on the organic layer 240, and the second alignment layer 21 may be formed below the pixel electrode 191. The first alignment layer 11 and the second alignment layer 21 are formed to face each other with the microcavity 305 therebetween, and connected to each other at the edge of the pixel area PX.

The first and second alignment layers 11 and 21 may be aligned in a vertical direction of the substrate 110 (disregarding those portions of alignment layers 11 and 21 on the sides of the microcavities 305). Alternatively, by performing a process of irradiating UV rays on the first and second alignment layers 11 and 21, the first and second alignment layers 11 and 21 may be aligned in a horizontal direction of the substrate 110. Any alignment direction is contemplated.

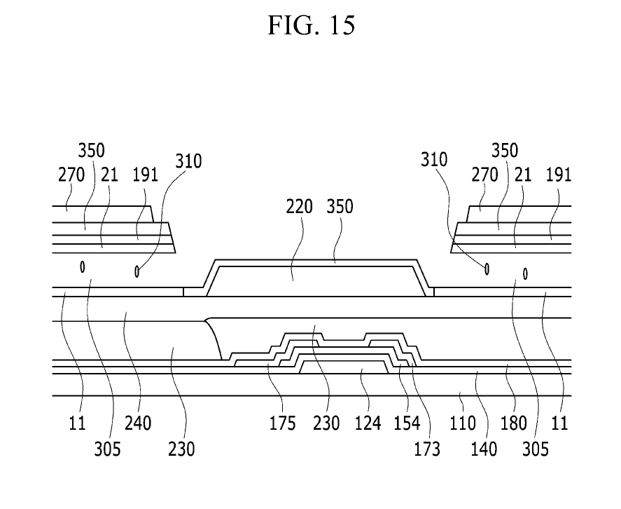

Next, referring to FIG. 15, when the liquid crystal molecules 310 are dropped on the substrate 110 by an inkjet method or a dispensing method, this liquid crystal material is injected into the microcavity 305 through the inlet 307.

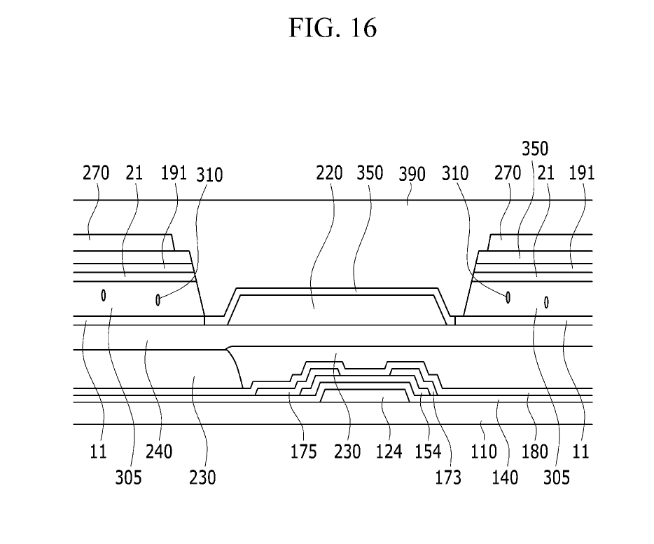

Next, as illustrated in FIG. 16, the overcoat 390 is formed by depositing a material which does not react with the liquid crystal molecules 370 on the common electrode 270. The overcoat 390 is formed to cover the inlets 307 so as to seal the microcavities 305.

That is, in the manufacturing method of the display device according to exemplary embodiments of the present invention, the number of processes and the number of masks are reduced as compared with a manufacturing method in the related art.

The following Table 1 illustrates processes and masks which are used in the display device according to the Comparative Example in which the roof layer, the insulating layer, the capping layer are separately formed in the related art, and the display device according to the exemplary embodiment of the present invention.

TABLE 1

| mask | Comparative Example | Example of the present invention |
|---|---|---|
| # | (13 masks) | (11 masks) |
| 1 | gate | gate |
| 2 | Source, drain | Source, drain |
| 3 | Color filter 1 | Color filter 1 |
| 4 | Color filter 2 | Color filter 2 |
| 5 | Color filter 3 | Color filter 3 |
| 6 | Organic layer | Organic layer |
| 7 | common electrode | Sacrificial layer |
| 8 | Insulating layer | Pixel electrode |
| 9 | Pixel electrode | Light blocking member |
| 10 | Light blocking member | Roof layer |
| 11 | Capping layer of light | Common electrode |
| | blocking member | (inlet of microcavity) |
| 12 | Sacrificial layer | |
| 13 | Roof layer (inlet of microcavity) | |

That is, as seen through the Table, in the display device according to exemplary embodiments of the present invention, the common electrode 270 and the pixel electrode 191 are positioned on the microcavity 305. The insulating layer between the common electrode 270 and the pixel electrode 191 also serves as the capping layer of the light blocking member 220 and the roof layer 350. As a result, the number of masks is reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Various features of the above described and other embodiments can be mixed and matched in any manner, to produce further embodiments consistent with the invention.

### <Description of Symbols>

| | |
|---|---|
| 11: First alignment layer | 21: Second alignment layer |

| | |
|---|---|
| 110: Substrate | 121: Gate line |
| 124: Gate electrode | 140: Gate insulating layer |
| 154: Semiconductor | 171: Data line |
| 180: Passivation layer | 191: Pixel electrode |
| 220: Light blocking member | 230: Color filter |
| 240: Organic layer | 350: Roof layer |

| | |
|---|---|
| 270: Common electrode | 300: Sacrificial layer |

| | |
|---|---|
| 305: Microcavity | 307: Inlet |
| 310: Liquid crystal molecule | 390: Overcoat |

What is claimed is:

1. A display device, comprising:
an insulation substrate including a plurality of pixel areas;
a thin film transistor positioned on the substrate;
an organic layer positioned on the thin film transistor;
a pixel electrode formed to be spaced apart from the organic layer with a microcavity therebetween, the pixel electrode being connected to the thin film transistor;
a common electrode overlapping the pixel electrode with a roof layer therebetween; and
a liquid crystal layer within the microcavity.

2. The display device of claim 1, further comprising:
an overcoat formed on the common electrode to seal the microcavity.

3. The display device of claim 1, wherein:
the display device further comprises a plurality of microcavities, the microcavities being arranged in a matrix form to respectively correspond to the plurality of pixel areas, and
a light blocking member is formed between microcavities adjacent in the column direction.

4. The display device of claim 3, wherein:
the roof layer at least partially covers the light blocking member.

5. The display device of claim 3, wherein:
the common electrode comprises a plurality of distinct electrodes each positioned on a respective one of the microcavities.

6. The display device of claim 3, wherein:
the common electrode comprises a single unitary and continuous electrode extending over more than one of the microcavities.

7. The display device of claim 1, further comprising:
an electrostatic protection electrode formed on a surface where the thin film transistor of the insulation substrate is not formed.

8. The display device of claim 7, wherein:
the electrostatic protection electrode is a transparent electrode substantially covering the insulation substrate.

9. The display device of claim 1, wherein:
the roof layer is an inorganic layer, and a thickness of the roof layer is from 0.5 μm to 0.8 μm.

10. The display device of claim 2, further comprising:
an organic roof layer formed on the common electrode.

11. The display device of claim 2, further comprising:
an inorganic layer formed on the common electrode.

12. The display device of claim 1, further comprising:
a color filter formed between the thin film transistor and the organic layer.

13. A method of manufacturing a display device, the method comprising:
forming a thin film transistor on a substrate;
forming an organic layer on the thin film transistor;
forming a sacrificial layer on the organic layer;
forming a pixel electrode on the sacrificial layer, the pixel electrode being connected to the thin film transistor;
forming a light blocking member on the organic layer so as not to overlap the sacrificial layer;
forming a roof layer on the pixel electrode and the light blocking member;
forming a common electrode on the roof layer and overlapping the pixel electrode;
exposing the sacrificial layer;
forming a microcavity between the organic layer and the pixel electrode by removing the exposed sacrificial layer;
forming a liquid crystal layer by injecting a liquid crystal material into the microcavity; and
forming an overcoat on the common electrode to seal the microcavity.

14. The method of claim 13, further comprising:
before the forming an organic layer on the thin film transistor, forming a color filter on the thin film transistor.

15. The method of claim 13, further comprising:
forming an electrostatic protection electrode on a surface of the insulation substrate upon which the thin film transistor is not formed.

16. The method of claim 13, further comprising:
before the forming an overcoat on the common electrode to seal the microcavity, forming an organic roof layer on the common electrode.

17. The method of claim 13, further comprising:
before the forming an overcoat on the common electrode to seal the microcavity, forming an inorganic layer on the common electrode.

18. The method of claim 13, wherein:
11 or fewer masks are used.

19. The method of claim 13, wherein:
the roof layer is an inorganic layer.

20. The method of claim 19, wherein:
a thickness of the roof layer is from 0.5 μm to 0.8 μm.
